(19) United States
(12) Patent Application Publication
(10) Pub. No.: US 2005/0203794 A1
(43) Pub. Date: Sep. 15, 2005

(54) Method of advertising at residential locations

(76) Inventors: E. Carter Corriston JR., Ramsey, NJ (US); Douglas Carlson, Allendale, NJ (US)

Correspondence Address: MCCARTER & ENGLISH, LLP, FOUR GATEWAY CENTER, 100 MULBERRY STREET, NEWARK, NJ, 07102, US

(21) Appl. No.: 10/796,409

(22) Filed: Mar. 9, 2004

(51) Int. Cl. G06F 17/60; G09F 1/00

(52) U.S. Cl. 705/14

(57) ABSTRACT

A method of advertising at residential locations is provided. Waste and/or recycling containers having advertising indicia related to one or more businesses are provided by the business to residents of the location at no cost to the residents. The residents are allowed to use the containers for disposing waste and/or recycling from households. The containers are positioned curbside by residents for collection, wherein the advertising indicia is displayed to others. Various types of containers, including removable-lid containers, roll-out type containers, and containers operable with automated trash removal equipment, can be utilized. The method can be applied to numerous locations and/or businesses.

### BACKGROUND OF THE INVENTION

1. Field of the Invention

The present invention relates to a method of advertising at residential locations.

2. Related Art

Individuals and families living in residential areas represent a significant market for businesses. Homeowners frequently require services provided by local businesses, such as landscaping, roofing, plumbing, masonry, electrical, and other similar services. To attract potential customers, various forms of advertising are utilized, including direct targeted mail, bulk mailings, and flyers. Further, advertisements are often placed in local newspapers and publications that are distributed to residents.

Often, local businesses provide signs that are placed on a resident's property when services are being provided. For example, landscaping services often place signs on the lawns of residential properties when landscaping, or shortly thereafter. However, this method is often ineffectual and temporary in nature, as many residents remove and discard the signs right after services have been performed. Such businesses also often place advertising indicia on the sides of their vehicles, but such a method allows for advertising when the vehicle is parked near the residence while services are provided. What would be desired, but has not heretofore been developed is a method for providing enduring advertising at residential locations.

Waste containers are commonly used in residential areas for waste disposal and recycling, and are available in various configurations. Conventional garbage cans (e.g., cans having removable lids and no wheels) and roll-out garbage cans (e.g., cans having wheels connected to a bottom portion thereof) are often used to dispose of waste from a household. Further, cans that can be emptied by automated disposal equipment are used in residential locations. Similarly, variously configured containers can be used for handling household recyclables.

While it is known to provide advertising indicia on stationary garbage cans in urban areas, such as waste receptacles that are located along city streets and anchored to the ground, such advertising methods are confined to urban environments, and have not been implemented in residential settings.

Accordingly, what would be desirable, but has not heretofore been provided, is a method of advertising at residential locations using waste and/or recycling containers having advertising indicia thereon.

### SUMMARY OF THE INVENTION

The present invention relates to a method for advertising at residential locations using waste or recycling containers. Containers for recycling and/or waste collection, having advertising indicia thereon, are provided to residents. They could be provided at full cost, or a reduced cost, but are preferably provided at no cost, to the residents, in locations where such containers are brought curbside for collection and where advertising is desirable. Residents are allowed to use the containers to dispose of garbage and/or for recycling. The advertising indicia is displayed and viewable by others when the container is positioned curbside by the resident for collection. The method can be practiced with conventional garbage cans, roll-out type garbage cans, garbage cans operable with automated disposal equipment, recycling containers, or any other container or can be made of any known material that is used in residential settings. The advertising indicia could be affixed to the distributed containers by stickers, or stickers could be provided to the resident at no cost and the residents encouraged to place the stickers on existing waste and/or recycling containers owned by the resident.

In an embodiment of the present invention, a method of advertising for businesses is provided. Locations are identified where advertising is desirable and containers are brought curbside for waste or recycling collection. Businesses in the location that desire to advertise in the location are identified. Waste and/or recycling containers are produced having advertising indicia thereon related to the businesses. The containers are sold to the businesses, and the businesses provide same to residents of the location at no cost. Residents are allowed to use the containers for waste disposal or recycling. When the containers are placed curbside for collection, the advertising indicia is visible by others in the surrounding area, thereby advertising the businesses indicated in the advertising indicia.

In another embodiment of the present invention, a method of advertising for a business is provided. A business that performs services at a resident's location provides to the resident a container having advertising indicia thereon related to the business, at no cost to the resident. The resident is allowed to use the container for waste disposal or recycling. When the container is placed curbside for collection, the advertising indicia is visible by others in the surrounding area, thereby advertising the business indicated in the advertising indicia.

### BRIEF DESCRIPTION OF THE DRAWINGS

These and other important objects and features of the invention will be apparent from the following Detailed Description of the Invention, taken in connection with the accompanying drawings, in which:

FIG. 1 is a flowchart showing the method of the present invention of advertising using waste and/or recycling containers at residential locations.

FIG. 2 is a flowchart showing an alternate embodiment of the method of advertising of the present invention.

FIG. 3 is a flowchart showing another embodiment of the method of advertising of the present invention.

FIG. 4 is a view showing a roll-out type container can having advertising indicia thereon and placed near a curb for collection.

FIG. 5 is a view showing a conventional container can having advertising indicia thereon and placed near a curb for collection.

### DETAILED DESCRIPTION OF THE INVENTION

The present invention relates to a method of advertising at residential locations using waste and/or recycling containers. Locations are identified in residential areas where advertising is desirable and where containers are brought curbside for collection. Containers having advertising indicia thereon related to one or more businesses within the location are produced. The containers are provided to residents of the location. The residents are allowed to use the containers for trash disposal and/or recycling. When the container is brought curbside for collection, the advertising indicia is visible to others in the surrounding area, thereby advertising the businesses to which the advertising indicia relates. The invention can be practiced with any type of container, including removable-lid garbage cans, roll-out type garbage cans, garbage cans operable with automated trash collection systems, and recycling containers. The invention is applicable to businesses that provide services in residential areas. The business can supply containers with advertising thereon to the residents. When the residents bring the containers curbside, the advertising can be viewed by others.

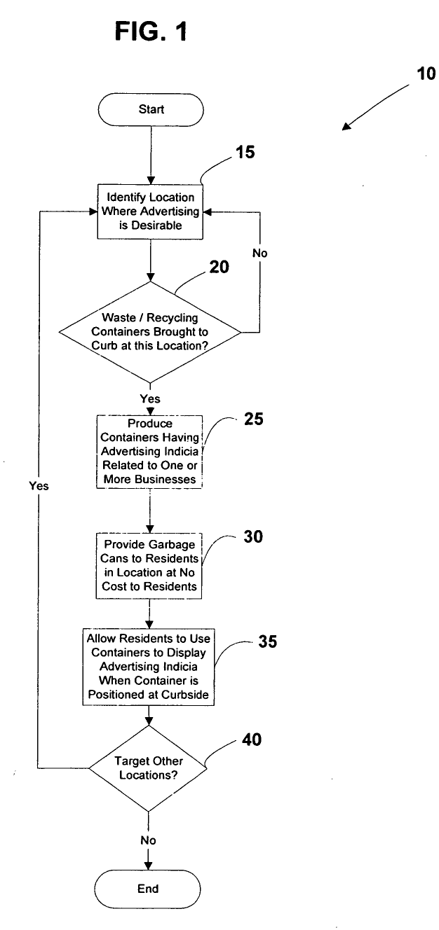

FIG. 1 is a flowchart showing the method of advertising of the present invention, indicated generally at 10. Beginning in step 15, a location is identified where a business, such as a bank, store, etc. would like to advertise. Preferably, the location is a residential location having a plurality of homes and residents, but of course, other locations (such as commercial locations, etc.) could conceivably be identified and the methods of the present invention utilized therein. In step 20, a determination is made as to whether waste and/or recycling containers utilized by residents of the location are brought curbside for collection. By the term “curbside,” it is meant any position distant from a house where garbage collection normally occurs, such as next to a curb, driveway, sidewalk, or other similar location. If a negative determination is made in step 20, step 15 is repeated, so that additional locations where advertising is desirable can be identified.

In the event that a positive determination is made in step 20, step 25 is performed, wherein the business produces waste and/or recycling containers having advertising indicia thereon. The advertising indicia preferably could include contact information including, but not limited to, telephone numbers, addresses, and websites. For example, the indicia could relate to a bank, and could include the address and telephone number of the bank, in addition to a slogan.

The advertising indicia can be placed on any desired portion of a container, such as a sidewall, lid, or any combination thereof. Further, the indicia can be placed on any type of waste and/or recycling container, including removable lid, hinged lid, and roll-out type garbage containers. Any means for affixing the indicia to the lid can be used, but preferably, the indicia is painted or applied to the sides of the can in a permanent fashion that withstands exposure to natural elements including rain, snow, wind, sunlight, and ultraviolet light extant in sunlight. Conceivably, advertising indicia in the form of stickers could be affixed to the sides of the containers, or stickers could be provided to residents at no cost and the residents encouraged to place the stickers on existing waste and/or recycling containers. In addition to advertising, the stickers could decorate the containers such that residents would find them desirable to use. Moreover, the advertising indicia is preferably sufficiently strong to withstand abrasion or contact with other objects, such as may occur when collection personnel empty containers and frequently throw same to the ground.

In step 30, once advertising indicia has been provided on the waste and/or recycling containers, the containers (or stickers) are distributed to residents of the location, at no cost to the resident. Any conceivable method for distributing the containers to residents can be employed. For example, flyers could be distributed within a town designating a date and location where the containers will be distributed for pickup by the residents. Further, the containers could be provided to local businesses and given free of charge to patrons of the businesses. Moreover, individuals could be recruited to canvass a town with the containers, going door-to-door and offering the containers to residents at no cost.

In step 35, after the containers have been distributed, the residents are allowed to use same for garbage disposal and/or recycling. Preferably, the residents are encouraged to use the containers in place of existing containers, or in addition thereto, for disposing garbage and/or recycling from the household. When the resident has filled the container, the container is brought curbside by the resident for collection. The advertising indicia on the container is visible by others when the can is positioned and remains curbside, thereby serving to advertise the businesses indicated in the indicia. For example, when individuals walk past the house, their attention is drawn to the advertising indicia, and the individuals are informed about the businesses indicated in the indicia. If the individuals have particular needs that could be satisfied by the businesses indicated in the indicia, the individuals will remember the contact information of the business and will contact the business after arriving at home. Additionally, individuals driving past the containers will similarly see the advertising indicia, remember same, and contact the businesses displayed by the advertising indicia.

After the containers have been provided to residents of the location, a determination is made in step 40 as to additional locations should be targeted. If a positive determination is made, step 15 is repeated, and the method 10 performed again for a new location. In this fashion, advertising can be targeted at multiple locations and multiple markets can be accessed.

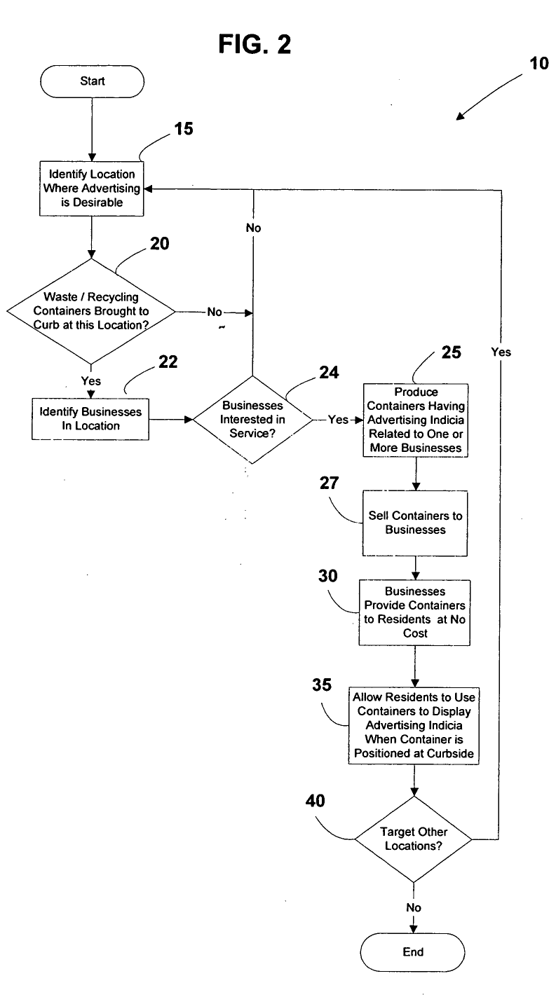

FIG. 2 is a flowchart showing an alternate embodiment of the advertising method of the present invention, wherein advertising services can be provided for a plurality of businesses in multiple locations. Beginning in step 15, a location is identified where advertising is desirable. Then, in step 20, a determination is made as to whether waste and/or recycling containers are brought curbside by residents of the location for collection. If a negative determination is made, step 15 is repeated, so that additional locations can be identified. If a positive identification is made, then in step 22, businesses within or proximal to the location are identified. It should be noted that not only can businesses within or proximal to the location can be identified in step 22, but also any business that has a potential market in residents of the location.

After businesses have been identified in step 22, a decision point is reached in step 24, wherein a determination is made as to whether the businesses are interested in advertising services. If at least one business is interested, step 25 is performed. Otherwise, step 15 is performed, wherein additional locations can be identified and the method 10 of the present invention applied thereto. The businesses can be queried in step 24 in a number of ways. For example, telephone calls can be made to each business ascertaining whether the business has an interest in advertising services. Additionally, flyers or other printed media can be distributed to the businesses describing the advertising services of the present invention and encouraging the businesses to participate. Of course, other ways of alerting businesses to the advertising method of the present invention are conceivable and are considered within the spirit and scope of the present invention.

After interested businesses have been identified, waste and/or recycling containers are produced in step 25 having advertising indicia thereon relating to the businesses. In step 27, the containers are then sold to the businesses. Then, in step 30, the containers are provided to residents of the location in the manners discussed earlier herein. In step 35, the residents are allowed to use the containers. When the containers are positioned curbside for collection, the advertising indicia is viewable by others in the area surrounding the garbage can, thereby advertising the businesses participating in the advertising service. Finally, in step 40, a determination is made as to whether there are other locations where the method 10 of the present invention is desired to be applied. If a positive determination is made, step 15 is repeated, and the steps illustrated in FIG. 2 and disclosed herein are performed again for a new location.

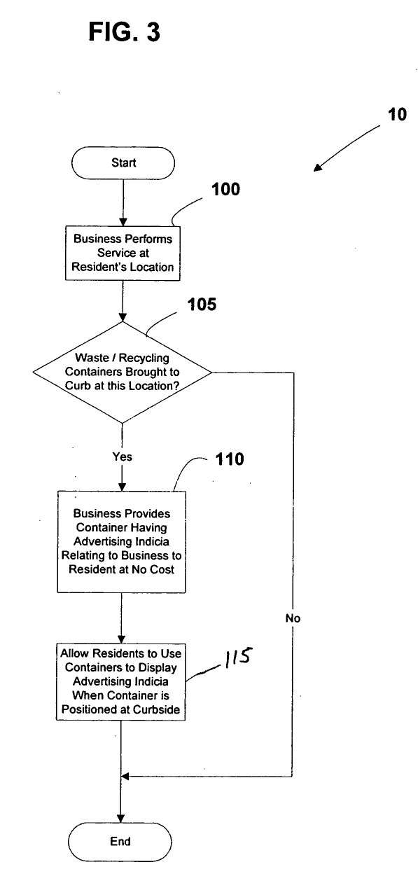

FIG. 3 is a flowchart showing another embodiment of the method of advertising of the present invention, indicated generally at 10. In step 100, a business performs services at a resident's location. Then, in step 105, a determination is made as to whether waste and/or recycling containers are brought to the curb at the location for collection. If a positive determination is made, step 110 is performed, the business provides a container having advertising indicia thereon related to the business to the resident, at no cost to the resident. In step 115, the resident is allowed to use the container for waste disposal and/or recycling. When the container is placed curbside for collection, the advertising indicia is visible by others in the surrounding area, thereby advertising the business and the services it has performed at that residence and as indicated in the advertising indicia.

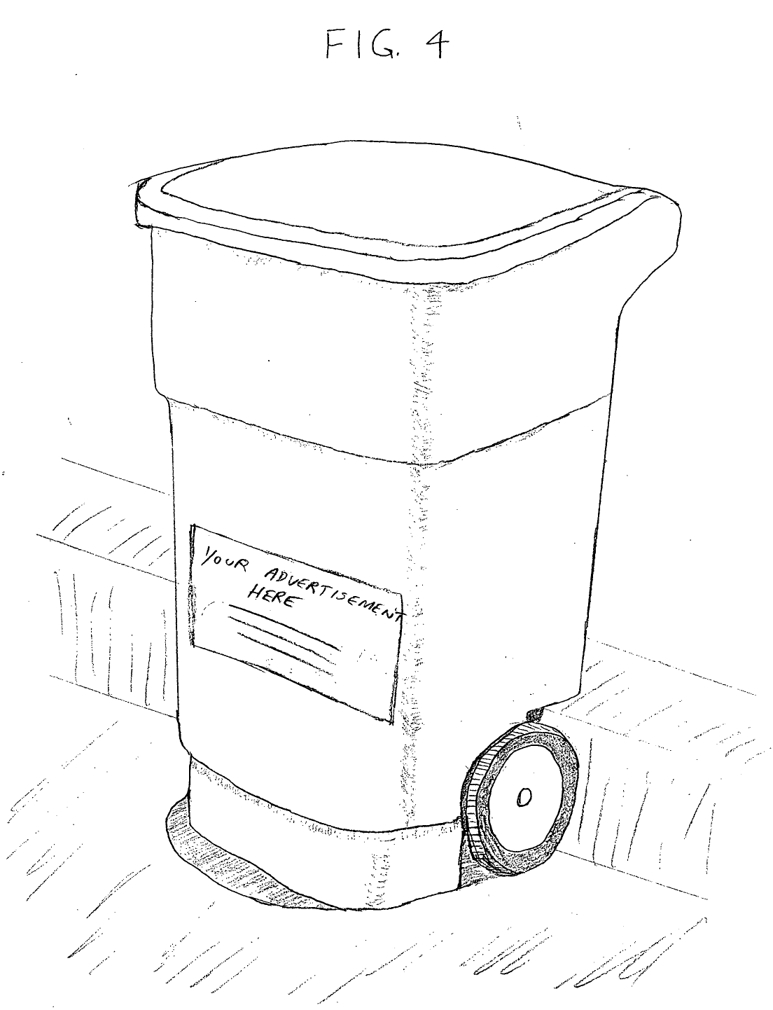

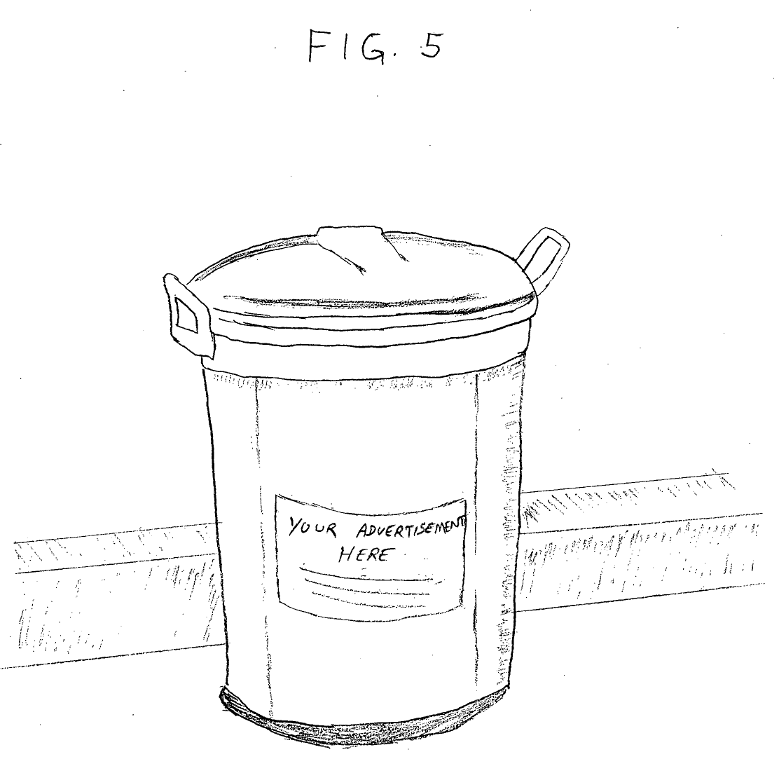

As previously mentioned, the present invention can be practiced with any type of garbage can, and preferably, with the types of garbage cans that are commonly used in residential areas. Two types of residential garbage cans having advertising indicia thereon in accordance with the present invention are shown in FIGS. 4 and 5. It is to be understood that the advertising indicia shown therein is purely illustrative in nature, and is not intended to limit the spirit or scope of the present invention. Indeed, any type of advertising indicia, whether textual, graphic, or otherwise, can be utilized with the present invention.

FIG. 4 is a view showing a roll-out type waste and/or recycling container configured according to the present invention to include advertising indicia, and placed curbside for disposal. The advertising indicia can relate to any business and preferably includes contact information about the business. As can be readily appreciated, when an individual passes near the container, the contact information about the business, in addition to any other desired information, is visible. In this fashion, a valuable advertising service is provided for the business, and the resident is provided with a high-quality container at no cost.

FIG. 4 is a view showing a conventional, lid-type waste and/or recycling container can having advertising indicia thereon. The container can be placed curbside for trash collection, and the indicia made visible to others.

Having thus described the invention in detail, it is to be understood that the foregoing description is not intended to limit the spirit and scope thereof. What is desired to be protected by Letters Patent is set forth in the appended claims.

1. A method of advertising at a residential location comprising:
providing a container having advertising indicia to a resident;
allowing the resident to use the container to dispose of waste or recycling near a curb; and
displaying the advertising indicia when the container is placed near the curb.

2. The method of claim 1, wherein the step of providing the container comprises providing the container to the resident at no cost to the resident.

3. A method of advertising at a residential location comprising:
identifying a location where advertising is desirable;
determining whether waste or recycling is brought curbside at the location;
producing containers having advertising indicia thereon;
providing the containers to residents of the location; and
allowing the residents to use the containers to dispose of waste or recycling, the advertising indicia being displayed when the containers are positioned curbside.

4. The method of claim 3, wherein the step of providing the containers comprises providing the containers to the residents at no cost to the residents.

5. The method of claim 3, further comprising providing containers having advertising indicia thereon to residents of additional locations.

6. The method of claim 4, wherein the step of producing the container comprises producing containers having advertising indicia relating to a business.

7. A method of advertising for businesses at residential locations comprising:
identifying a location where advertising is desirable;
determining whether waste or recycling is brought curbside at the location;
identifying at least one business interested in advertising services in the location;
producing containers having advertising indicia relating to the business;
selling the containers to the business;
allowing the business to provide the containers to residents of the location; and
allowing the residents to use the containers to dispose of waste or recycling, the advertising indicia being displayed when the containers are positioned curbside.

8. The method of claim 7, wherein the step of allowing the business to provide the containers comprises allowing the business to provide the containers to the residents of the location at no cost to the residents.

9. The method of claim 7, further comprising:
determining additional locations where advertising is desirable;
determining additional businesses interested in advertising in the locations;
providing containers to the additional businesses having advertising indicia relating to the additional businesses;
allowing the businesses to provide the containers to residents of the additional locations; and
allowing the residents to use the containers to dispose of waste or recycling, the advertising indicia being displayed when the containers are brought curbside for collection.

10. A method of advertising for businesses at residential locations comprising:
performing a service at a resident's location;
determining whether waste or recycling is brought curbside at the location;
providing a container having advertising indicia relating to the services performed at the location; and
allowing the resident to use the container to dispose of waste or recycling, the advertising indicia being displayed when the container is positioned curbside.

11. The method of claim 10, wherein the step of providing the container comprises provide a container having advertising indicia relating to the business to the resident at no cost to the resident.
